(19) United States
(12) Patent Application Publication
(10) Pub. No.: US 2014/0021721 A1
(43) Pub. Date: Jan. 23, 2014

(54) METHOD AND APPARATUS FOR EFFICIENT BALANCING BASELOAD POWER GENERATION PRODUCTION DEFICIENCIES AGAINST POWER DEMAND TRANSIENTS

(71) Applicants: Charles D. Barton, Chicago, IL (US); Michael S. Carr, Dixon, IL (US)

(72) Inventors: Charles D. Barton, Chicago, IL (US); Michael S. Carr, Dixon, IL (US)

(21) Appl. No.: 13/946,879

(22) Filed: Jul. 19, 2013

Related U.S. Application Data
(60) Provisional application No. 61/673,632, filed on Jul. 19, 2012.

(51) Int. Cl. H02K 57/00

(52) U.S. Cl. CPC H02K 57/003
USPC 290/54

(57) ABSTRACT

The invention provides an apparatus for electric power generation. The apparatus includes an electrical power generating facility coupled to the plasma facilitated thermal reduction apparatus through switch gear; a plasma facilitated thermal reduction module communicates with the electric power generating facility thought switch gear. A gas turbine electric generator communicates with the electrical power generating facility; a hydrogen generating module communicates with the gas turbine electric generator; and a steam turbine generator communicates to the hydrogen generating module whereby the direct application of otherwise unused grid distributed electrical power towards the synthesis of storable hydrocarbon energy carrier molecules.

### RELATED APPLICATIONS

This application claims the benefit of U.S. Provisional Application Ser. No. 61/673,632 filed Jul. 19, 2012, the complete subject matter of which is incorporated herein by reference in its entirety.

### FIELD OF THE INVENTION

The invention relates to generally to energy and renewable energy. More specifically embodiments of the present invention relate to a method and apparatus for the efficient balancing of baseload power generation production deficiencies against electrical power demand transients or alternatively as a functional grid storage.

### BACKGROUND OF THE INVENTION

As modern society struggles with the idea of ‘global warming’, ‘global climate change and the role fossil sourced energy production plays in it, several non-fossil production technologies have been devised and deployed including wind and solar based solutions. As these techniques struggle to find their niche in the larger scheme it is clear that, collectively, they cannot currently displace our reliance on fossil sourced fuels for energy production but rather contribute in a supportive manner.

The modern electrical power distribution network or ‘grid’ is fed by several different categories of power generating facilities including ‘baseload’, ‘peaking’ and ‘rolling’ plants and each has been devised to address specific aspects of constantly variable electrical power demand. As the name suggests, ‘baseload’ power is the minimum average required grid distributed power to be supplied on a 24/7 basis, with ‘peaking’ and ‘rolling’ plant generated power available to supplement as needed based on variable and transient increases in demand. As the electric ‘grid’ functions now, baseload power is primarily supplied from coal, hydroelectric and nuclear power plants along with increasing amounts of wind power and natural gas combustion turbine generators are used for the ‘peaking’ and ‘rolling’ plants. Since ‘spikes’ in demand cannot be completely predicted and deficiencies in available power are not currently tolerated, this necessitates that a surplus of power is constantly being generated and wasted. Wind power is more problematic in that in addition to the above described inefficiencies, it is also constrained by wind availability itself, so its efficiencies and profitability are limited by two variables.

The previous discussion illustrates that in its current operating configuration the electric grid necessarily introduces energetic waste and the implications of its resulting introduction of CO2 into the atmosphere, though not spoken of, should be obvious. But there are purely economic components to the inefficiencies as well. Surplus baseload power that is not used reflects an accountable waste of fossil and other feedstocks, manpower, facility overhead, released CO2 and even the energetic value of the released heat itself. Additionally, ‘peaking’ plants are expensive facilities that are designed, built and manned 24/7 which are, in some cases, only operated for a few hours a year. ‘Rolling’ plants are similar but wastefully run continuously at idle, ready to address any supply shortfall introduced by rapidly fluctuating demand.

For the foregoing reasons, it would be desirable to provide the method and apparatus described herein was conceived to directly address and reduce the above described inefficiencies and is now presented as a practical solution for functional grid storage.

### SUMMARY OF THE INVENTION

One embodiment of invention relates to an apparatus for electric power generation. The apparatus includes an electrical power generating facility coupled to the plasma facilitated thermal reduction apparatus through switch gear; a plasma facilitated thermal reduction module communicates with the electric power generating facility thought switch gear. A gas turbine electric generator communicates with the electrical power generating facility; a hydrogen generating module communicates with the gas turbine electric generator; and a steam turbine generator communicates to the hydrogen generating module whereby the direct application of otherwise unused grid distributed electrical power towards the synthesis of storable hydrocarbon energy carrier molecules.

Still another embodiment relates to a method of electric power generation using any of the apparatus described previously. The method comprises introducing energetically useful carbonaceous feedstocks; and reducing the feedstocks to their fundamental constituent gaseous components. The method includes cooling the components generating recoverable heat energy and filtering the cooled recovered heat energy. The cooled recovered heat energy is routed to an energy carrier and the unused electrical power is redirected by a logical switching apparatus to a hydrogen generating module and the resulting product hydrogen is routed to energy carrier synthesis module where it is combined with product synthesis gas in optimized reactant ratios for assembly into variable, storable petrochemical analogs, allowing for operation of constituent sub-processes based on input feedstock, available surplus power constraints and desired output products.

Yet another embodiment relates to a method of electric power generation using an apparatus, wherein the apparatus comprises a plasma facilitated thermal reduction apparatus communicating with an electrical power generating facility though a logical switch apparatus; a gas turbine electric generator communicating with the electrical power generating facility; a hydrogen generating module communicating with the gas turbine electric generator; and a steam turbine generator communicating with the hydrogen generating module. The method includes introducing energetically useful carbonaceous feedstocks into the plasma facilitated thermal reduction module; reducing the feedstocks to their fundamental constituent gaseous components; cooling the components generating recoverable heat energy; filtering the cooled recovered heat energy; routing the cooled recovered heat energy to an energy carrier; redirecting unused electrical power by the logical switching apparatus to the hydrogen generating module and resulting product hydrogen is routed to energy carrier synthesis module where it is combined with product synthesis gas in optimized reactant ratios for assembly into variable, storable petrochemical analogs, allowing for operation of constituent sub-processes based on input feedstock, available surplus power constraints and desired output products.

Other embodiments relate to using the apparatus in total or in part, to facilitate the introduction of a non fossil sourced baseload electrical power generating option.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a high level block diagram of electrical power generating facilities (F) shown energizing the ‘grid’ to provide power to consumers;

FIG. 2 illustrates a methanation reactor in accordance with one embodiment;

FIG. 3 illustrates a diagram of a Fischer-Tropsch reactor in accordance with one embodiment;

FIG. 4 illustrates a illustrating a reactor without a hydrocarbon synthesis module attached in accordance with one embodiment.

Throughout the various figures, like reference numbers refer to like elements.

### DETAILED DESCRIPTION OF PRESENTLY PREFERRED EMBODIMENTS

Embodiments of the present invention relate to energy and renewable energy. More specifically embodiments of the present invention relate to a method and apparatus for the efficient balancing of baseload power generation production deficiencies against electrical power demand transients or alternatively as a functional grid storage.

More specifically embodiments of the method and apparatus described herein was conceived to directly address and reduce the above described inefficiencies and is now presented as a practical solution for functional grid storage. This method provides an effective mechanism for converting surplus electrical power and waste heat into energy in a storable form for later use, distribution or sale. Carbonaceous material of any source (fossil, carbon neutral or non-fossil) is reduced to synthesis gas (primarily carbon monoxide and hydrogen gas) through efficient plasma gasification. Surplus electrical power and waste heat from baseload or wind power generating facilities is logically routed to a proximally located electrolyzer which reduces water to oxygen and hydrogen gas. The hydrogen gas is introduced into a reactor vessel along with the product synthesis gas facilitating optimized reactant ratios to produce synthetic natural gas (SNG or methane) in the case of a coupled ‘methanation’ reaction or more complicated liquid fuels in the case of a coupled ‘Fischer-Tropsch’ reaction. Regardless of the hydrocarbon synthesis mechanism used, surplus electrical power and waste heat are converted to storable hydrocarbon energy carriers effectively creating a grid surge storage volume. Additional and flexible method functionality can be realized with respect to the current inefficiencies seen in the transportation of ‘fuels’ as well. Surplus electrical power and waste heat converted to SNG at point A for example, can be either injected into the natural gas pipeline for sale to point B, or compressed for truck transport to point B, OR combusted at point A to generate electrical power which is logically routed to point B through the existing grid. Clearly, innumerable permutations of translation and distribution are possible with this method and when considering the cumulative effect of all currently unused surplus power sources being applied to the production of storable energy products in this manner, very significant environmental, energetic and economic impacts can be realized. With regards to CO2 emissions, it should be noted that the CO2 currently released as a consequence of generating unused surplus power can now be attributed to the creation of useful energetic products, and, if landfill bound wastes are used, the passive CO2 emissions these wastes would generate in a landfill over time can be similarly attributed.

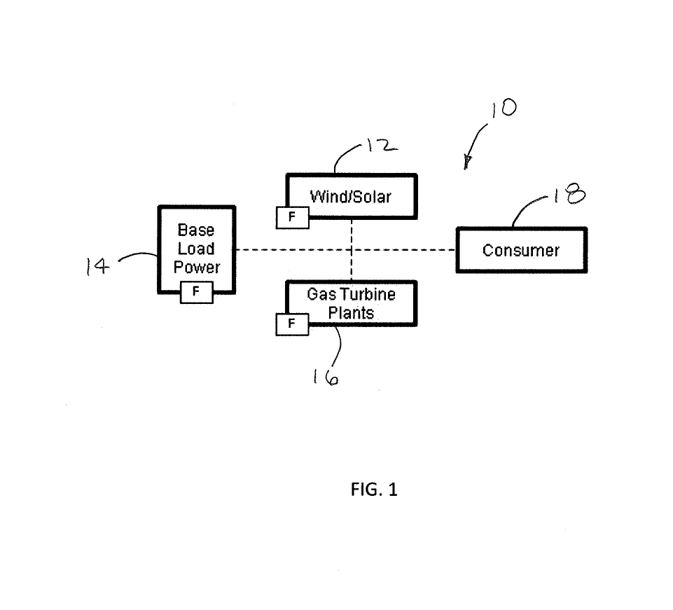

FIG. 1 is diagram illustrating a highly stylized representation of electrical power generating facilities (F) generally designated 10, including for example, wind/solar 12, base load power 14 and/or gas turbine plants 16 shown energizing the ‘grid’ to provide power to consumers 18.

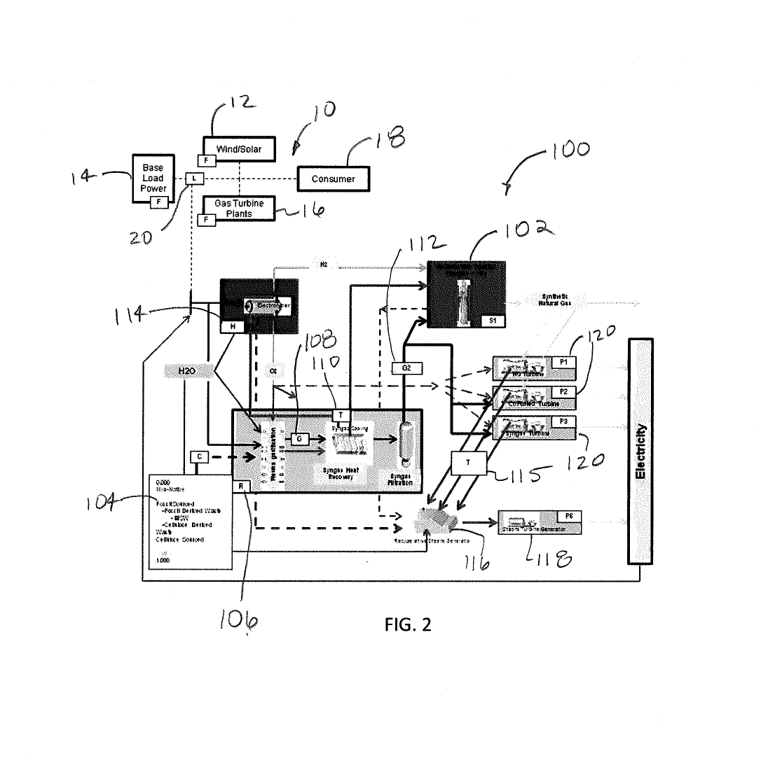

FIG. 2 is a diagram illustrating an apparatus 200 including a methanation reactor 102 as the coupled hydrocarbon synthesis module of choice (S1) which produces a desired final storable output product of Synthetic Natural Gas (SNG). Carbonaceous waste (C) 104 (of fossil, carbon neutral or non-fossil origin) is introduced into the thermal reduction module (R) 106, where it is reduced to its constituent molecular components (variably a mixture of carbon monoxide and hydrogen gas) collectively referred to as synthesis gas (G) 108. The synthesis gas is cooled producing recoverable heat energy (T) 110 and is then filtered to yield clean, cooled synthesis (G2) 112 available for downstream processing.

A hydrogen generating module (H) 114 is attached to the electrical power generating facility (F) 16 along with the logical switching gear (L) 20 required to control the transmission of electrical power to the grid (CONSUMER 18) and to the hydrogen generating module (H) 114. Electrical power is provided to the hydrogen generating module (H) 114 which then separates water (H2O) into oxygen (O2) and hydrogen gas (H2), both of which are made available for downstream processing.

In at least one embodiment, clean and cooled synthesis gas (G2) 112 is introduced into the methanation reactor 102 (energy carrier synthesis module, S1) along with the appropriate proportion of hydrogen gas (H2) and the methanation reaction is propagated to produce storable synthetic natural gas. Recovered heat energy (T) 115 is routed to hydrogen generating module (H) 116, and/or energy carrier synthesis module (S1) 102 as needed to optimize the respective sub-process efficiencies. Any remaining heat energy (T) 115 can be routed to an existing facility recuperative stream generator 116 for introduction into a steam turbine generator (P6) 118 for the generation of additional electric power. Produced synthetic natural gas can be stored for later use, or, injected into the natural gas grid for distribution and sale, or, combusted in a gas turbine electric generator (P1, P2) 120 for direct conversion back into useable electric power. Oxygen gas (O2) produced by the hydrogen generating module (H) is available for optimizing the thermal reduction unit, or for co-fueling the turbine electric generator (P1, P2) 120 for emissions reductions, or for direct sale.

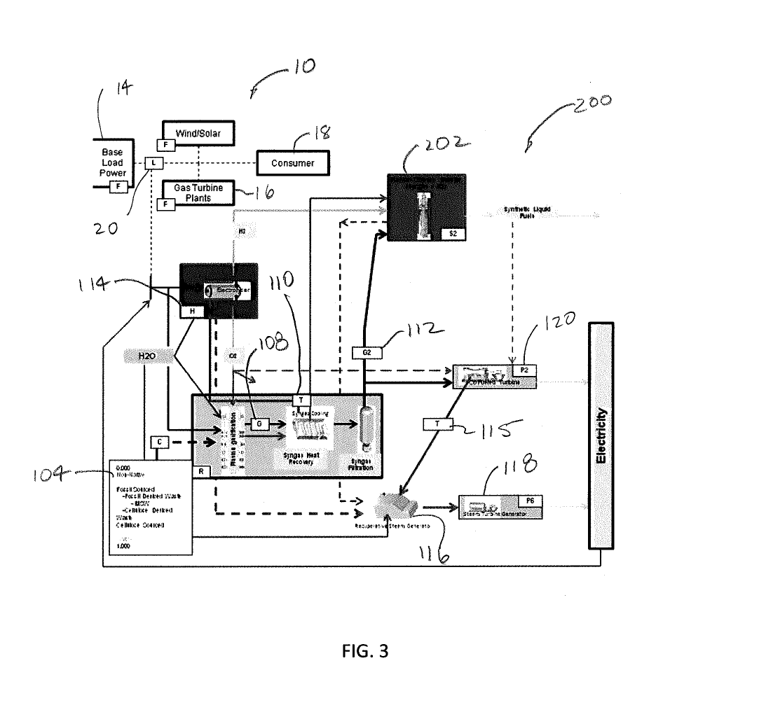

FIG. 3 depicts a diagram of an apparatus 200 having a Fischer-Tropsch reactor 202 as the coupled hydrocarbon synthesis module of choice (S2) 102 which produces a desired final storable output product of variable length hydrocarbon energy carrier molecules. Carbonaceous waste (C) 104 (of fossil, carbon neutral or non-fossil origin) is introduced into the thermal reduction module (R) 106, where it is reduced to its constituent molecular components (variably a mixture of carbon monoxide and hydrogen gas) collectively referred to as synthesis gas (G) 108. The synthesis gas is cooled producing recoverable heat energy (T) 114 and is then filtered to yield clean, cooled synthesis (G2) 112 available for downstream processing. A hydrogen generating module (H) 114 is attached to an electrical power generating facility (F) 12, 14, 16 along with the logical switching gear (L) 20 required to control the transmission of electrical power to the grid (CONSUMER 18) and to the hydrogen generating module (H) 114. Electrical power is provided to the hydrogen generating module (H) 114 which then separates water (H2O) into oxygen (O2) and hydrogen gas (H2), both of which are made available for downstream processing.

Clean and cooled synthesis gas (G2) 112 is introduced into the Fischer-Tropsch reactor 202 (energy carrier synthesis module, S2) along with the appropriate proportion of hydrogen gas (H2) and the synthesis reaction is propagated to produce storable hydrocarbon energy carrier molecules. Recovered heat energy (T) 110 is routed to hydrogen generating module (H) 114, and/or energy carrier synthesis module (S2) 102 as needed to optimize the respective sub-process efficiencies. Any remaining heat energy (T) 115 can be routed to an existing facility recuperative stream generator 116 for introduction into a steam turbine generator (P6) 118 for the generation of additional electric power. Produced hydrocarbons can be stored, distributed for sale, or, combusted in a gas turbine electric generator (P2) 120 for direct conversion back into useable electric power. Oxygen gas (O2) produced by the hydrogen generating module (H) 114 is available for optimizing the thermal reduction unit, or for co-fueling the turbine electric generator (P2) 120 for emissions reductions, or for direct sale.

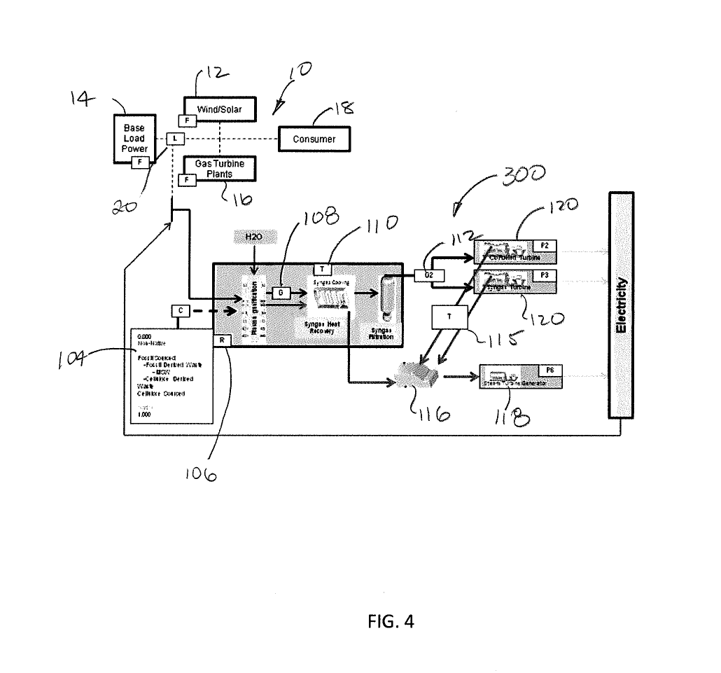

FIG. 4 depicts a diagram illustrating an embodiment 300 without a hydrocarbon synthesis module attached. Carbonaceous waste (C) 104 (of fossil, carbon neutral or non-fossil origin) is introduced into the thermal reduction module (R) 106, where it is reduced to its constituent molecular components (variably a mixture of carbon monoxide and hydrogen gas) collectively referred to as synthesis gas (G). The synthesis gas is cooled producing recoverable heat energy (T) 110 and is then filtered to yield clean, cooled synthesis gas (G2) 112 which is combusted in either a synthesis gas combustion turbine generator (P3) 120 or a synthesis gas/natural gas co-fueled combustion turbine generator (P2) 120 to produce electrical power. Heat (T) 115 recovered from synthesis gas cooling and from combustion turbine exhaust is routed to a recuperative steam generator 116 for introduction into a steam turbine generator (P6) 118 for the generation of additional electric power. In this embodiment there is no facility for converting surplus energy into storable hydrocarbon energy carrier molecules, otherwise wasted surplus energy is applied to the gasification of carbonaceous materials into synthesis gas which is then combusted to produce electrical power.

One embodiment of the method relates to a method of electric power generation using any of the apparatus described previously. The method comprises introducing energetically useful carbonaceous feedstocks; and reducing the feedstocks to their fundamental constituent gaseous components. The method includes cooling the components generating recoverable heat energy and filtering the cooled recovered heat energy. The cooled recovered heat energy is routed to an energy carrier and the unused electrical power is redirected by a logical switching apparatus to a hydrogen generating module and the resulting product hydrogen is routed to energy carrier synthesis module where it is combined with product synthesis gas in optimized reactant ratios for assembly into variable, storable petrochemical analogs, allowing for operation of constituent sub-processes based on input feedstock, available surplus power constraints and desired output products.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. An apparatus for electric power generation comprising:
an electrical power generating facility;
a plasma facilitated thermal reduction module communicating with the electrical power generating facility though a switch gear;
a gas turbine electric generator communicating with the electrical power generating facility;
a hydrogen generating module communicating with the gas turbine electric generator; and
a steam turbine generator communicating with the hydrogen generating module whereby otherwise unused grid distributed electrical power is applied towards the synthesis of storable hydrocarbon energy carrier molecules.

2. The apparatus of claim 1 further comprising a hydrocarbon synthesis module communicating with at least the plasma facilitated thermal reduction apparatus.

3. The apparatus of claim 2 wherein the hydrocarbon synthesis module comprises a methanation reactor.

4. The apparatus of claim 2 wherein the hydrocarbon synthesis module comprises a Fischer-Tropsch reaction apparatus.

5. The apparatus of claim 2 further comprising a hydrogen gas generating apparatus coupled to the hydrocarbon synthesis module.

6. A method of electric power generation comprising:
introducing energetically useful carbonaceous feedstocks;
reducing the feedstocks to their fundamental constituent gaseous components;
cooling the components generating recoverable heat energy;
filtering the cooled recovered heat energy;
routing the cooled recovered heat energy to an energy carrier;
redirecting unused electrical power by a logical switching apparatus to a hydrogen generating module and routing resulting product hydrogen to energy carrier synthesis module where it is combined with product synthesis gas in optimized reactant ratios for assembly into variable, storable petrochemical analogs, allowing for operation of constituent sub-processes based on input feedstock, available surplus power constraints and desired output products.

7. The method of claim 6 further comprising the recovered heat energy is directed to at least one of a power generating module for direct power generation, a hydrogen generating module or an energy carrier synthesis module to increase respective sub-process efficiencies.

8. The method of claim 6 wherein the carbonaceous feedstocks comprises at least one of a fossil, carbon neutral or non-fossil origin.

9. A method of electric power generation using an apparatus, wherein the apparatus comprises:
a plasma facilitated thermal reduction apparatus communicating with an electrical power generating facility though a logical switch apparatus;
a gas turbine electric generator communicating with the electrical power generating facility;
a hydrogen generating module communicating with the gas turbine electric generator; and
a steam turbine generator communicating with the hydrogen generating module;
the method comprising:
introducing energetically useful carbonaceous feedstocks into the plasma facilitated thermal reduction module;
reducing the feedstocks to their fundamental constituent gaseous components;
cooling the components generating recoverable heat energy;
filtering the cooled recovered heat energy;
routing the cooled recovered heat energy to an energy carrier;
redirecting unused electrical power by the logical switching apparatus to the hydrogen generating module and resulting product hydrogen is routed to energy carrier synthesis module where it is combined with product synthesis gas in optimized reactant ratios for assembly into variable, storable petrochemical analogs, allowing for operation of constituent sub-processes based on input feedstock, available surplus power constraints and desired output products.

10. The method of claim 9 comprising facilitating the introduction of a non fossil sourced baseload electrical power generating option.
